(19) United States
(12) Patent Application Publication
(10) Pub. No.: US 2026/0237007 A1
(43) Pub. Date: Aug. 13, 2026

(54) AUTOMATED ESTIMATION SYSTEM AND METHOD FOR CONSTRUCTION PROJECTS

(71) Applicant: OnPoint Roofing, LP, Houston, TX (US)

(72) Inventors: Matthew Easterly, Houston, TX (US); Rich Cash, Rockport, TX (US); Tyler McDonough, Rockport, TX (US)

(73) Assignee: OnPoint Roofing, LP, Houston, TX (US)

(21) Appl. No.: 19/531,843

(22) Filed: Feb. 6, 2026

Related U.S. Application Data
(60) Provisional application No. 63/756,787, filed on Feb. 10, 2025.

(51) Int. Cl. G06Q 50/08; G06F 8/61; G06Q 10/1093; G06Q 30/0601

(52) U.S. Cl. CPC G06Q 50/08; G06F 8/61; G06Q 10/1093; G06Q 30/0611; G06Q 30/0641

(57) ABSTRACT

A method for providing an estimate for a roof replacement project, the method utilizing a system including at least one server, at least one database and at least one communication device that are configured for wireless data communication over a network, the method includes installing, on a website of an entity, a custom-coded plugin widget having at least one pop-up interface, accessing, by an individual, the website, and navigating the website to a first pop-up interface. The method includes inputting by the individual, via the first pop-up interface, information corresponding to the individual and the roof replacement project. The custom-coded plugin widget is configured to communicate with the system to generate, based on the information, an estimate for the roof replacement project and display, via a second pop-up interface, the estimate to the individual for approval.

### CROSS-REFERENCE TO RELATED APPLICATIONS

This application claims the benefit of, and priority to, U.S. Provisional Patent Application No. 63/756,787, filed on Feb. 10, 2025, AND entitled “AUTOMATED ESTIMATION SYSTEM AND METHOD FOR CONSTRUCTION PROJECTS,” the contents of which are hereby incorporated by reference in its entirety.

### TECHNICAL FIELD

The present disclosure relates generally to systems and methods for estimating construction projects and, more particularly, but not by way of limitation, to a system capable of providing estimates for roofing projects in an automated manner.

### BACKGROUND

This section provides background information to facilitate a better understanding of the various aspects of the disclosure. The statements in this section of this document are to be read in this light, and not as admissions of prior art.

For roof replacement or repairs, homeowners typically ask several roofing contractors to provide written estimates to repair or replace a roof on a house. Typically, the homeowners schedule an appointment with each roofing contractor to visit the house for roof inspection to determine the style of roof, take measurements, and to inspect the area around the house for access and cleanup. Some contractors utilize aerial imaging data that has existed for years; however, it has remained incumbent on an end user (e.g., purchaser or homeowner) to determine how to interpret the data for use. The same is true for cost estimation software, building/materials pricing and lending/financing information. Using this information, the roofing contractor prepares a written estimate for the homeowner. Oftentimes, there are delays in receiving the written estimates due to, for example, weather, traffic, roofing contractor's availability, or the like. After receiving several estimates from different roofing contractors, the homeowner selects the contractor of their liking. There is a long-felt but unresolved need for a system or method that can automate roof replacement or repairs process by providing homeowners with estimates to repair or replace the roof on the house without a need for the contractor to physically visit the house for roof inspection.

### SUMMARY

A method for providing an estimate for a roof replacement project, the method utilizing a system including at least one server, at least one database and at least one communication device that are configured for wireless data communication over a network, the method includes installing, on a website of an entity, a custom-coded plugin widget including at least one pop-up interface, accessing, by an individual, the website, and navigating, by the individual, the website to a first pop-up interface. The method further includes inputting by the individual, via the first pop-up interface, information corresponding to the individual and the roof replacement project. The custom-coded plugin widget is configured to communicate with the system to generate, based on the information, an estimate for the roof replacement project and display, via a second pop-up interface, the estimate to the individual for approval.

A system includes at least one server, at least one database and at least one communication device. The at least one server, the at least one database, and the at least one communication device are each communicably coupled to a network for data communication. At least one of the at least one server, the at least one database and the at least one communication device are configured to install, on a website of an entity, a custom-coded plugin widget comprising at least one pop-up interface. An individual accesses the website, navigates the website to a first pop-up interface and inputs, via the first pop-up interface, information corresponding to the individual and the roof replacement project. The custom-coded plugin widget generates, based on the information, an estimate for the roof replacement project and displays, via a second pop-up interface, the estimate to the individual for approval.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary system for providing estimates for construction projects in an automated manner;

FIG. 2 illustrates an exemplary image and a corresponding mask;

FIG. 3 is a visual representation for installing a custom-coded plugin widget on a website of an entity according to an exemplary embodiment;

FIG. 4 illustrates the custom-coded plugin widget according to an exemplary embodiment;

FIG. 5 illustrates a visual representation of an exemplary roofing estimate; and

FIG. 6 is a flow diagram of an illustrative process for providing estimates for projects in an automated manner.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

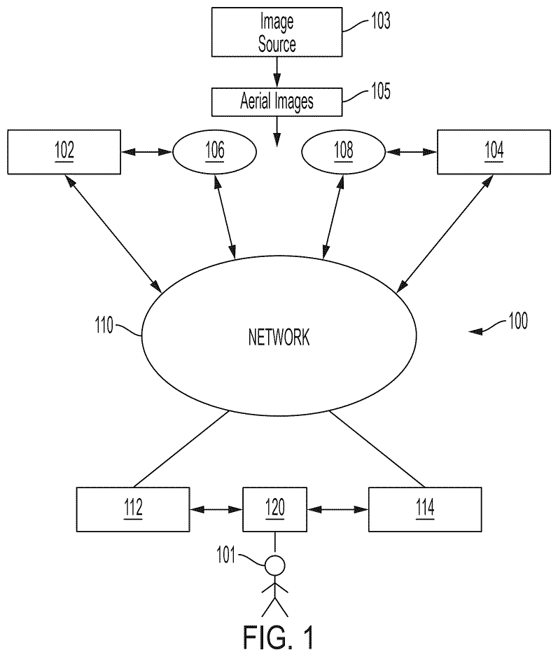

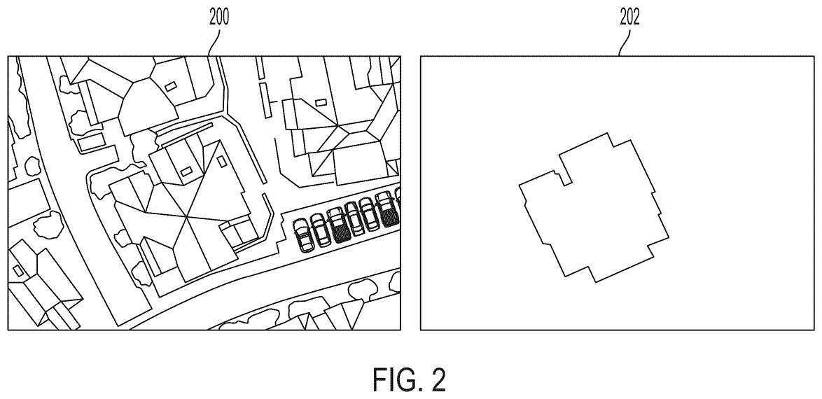

FIG. 1 illustrates an exemplary system 100 for providing estimates for construction projects in an automated manner. FIG. 2 illustrates an exemplary image 200 and a corresponding mask 202. In one embodiment, the exemplary system 100 executes as, for example, a desktop computer application. In another embodiment, the exemplary system 100 executes as a network-accessible service via, for example, a Web server, which may be operated remotely by an individual 101. In a typical embodiment, the individual 101 may be, for example, a user or a customer requesting estimates for a construction project. In a typical embodiment, construction projects may be, for example, roof repair, roof replacement, or the like for a specified building. In another embodiment, the exemplary system 100 utilizes a custom-coded plugin widget, installable on a backend of a website of an entity. In a typical embodiment, the entity may be, for example, an organization providing constructions services, roofing contractors, or the like.

Referring now to FIGS. 1-2, the system 100 includes a plurality of servers or cloud-computing systems 102, 104, a plurality of databases 106, 108, and a plurality of communication devices 112, 114. For illustrative purposes, only two servers or cloud-computing systems 102, 104, two databases 106, 108 for storing data, and two communication devices 112, 114 are illustrated; however, in alternate embodiments, any number of servers or cloud-computing systems, databases, and communication devices can be utilized as dictated by design requirements.

The plurality of servers or cloud-computing systems 102, 104, the plurality of databases 106, 108, and the plurality of communication devices 112, 114 are each communicably coupled to a network 110. The network 110 can include any number of wired and/or wireless communication networks such as, for example, public or private intranets, a wide area network (e.g., the Internet), cellular networks, satellite communication, or the like. In a typical embodiment, the plurality of servers or cloud-computing systems 102, 104 may be, for example, a personal computer (e.g., desktop or laptop), tablet computer, mobile device (e.g., personal digital assistant (PDA) or smart phone), or the like. In similar fashion, the plurality of communication devices 112, 114 may be, for example, a personal computer (e.g., desktop or laptop), tablet computer, mobile device (e.g., personal digital assistant (PDA) or smart phone), of the like. The exemplary system 100 can be implemented in a distributed environment comprising multiple, even heterogeneous, computer systems and networks. For example, various components of the exemplary system 100 may all be located in physically different computer systems or may be hosted on separate servers. Additionally, one or more of the components of the exemplary system 100 may themselves be distributed, pooled or otherwise grouped for load balancing, reliability or security reasons.

In a typical embodiment, the exemplary system 100 is communicatively coupled to the individual 101 and an image source 103. For example, the at least one server or cloud-computing system 102, 104 may be associated with or in communication with an external service provider that provides, for example, aerial images of the specified building. In particular, the at least one server or cloud-computing system 102, 104 is configured to communicate with the image source 103 such as, for example, Google™, Eagleview, or the like to obtain aerial images of the specified building. In a typical embodiment, the image source 103 may be any provider of aerial images 105 of the building for which a roof replacement estimate is being requested. In one embodiment, the image source 103 includes a computing system that provides access to a repository of aerial images 105 of one or more buildings. The aerial images 105 may include images obtained via, for example, manned or unmanned aircraft (e.g., airplane, helicopter, blimp, drone, etc.), satellite, or the like. Furthermore, the aerial images 105 may include images obtain via, for example, one or more ground-based platforms such as, for example, a vehicle-mounted camera that obtains street-level images of buildings, a nearby building, a hilltop, of the like. In some cases, a vehicle-mounted camera may be mounted in an elevated position, such as a boom.

In a typical embodiment, the one or more aerial images 105 of the specified building are obtained by, for example, providing an indicator of a location of the specified building (e.g., street address, GPS coordinates, lot number, or the like) to the image source 103 via at least one of the plurality of communication devices 112, 114. In one embodiment, the location of the specified building can be provided by the individual 101 (e.g., via a user-communication device 120). In other embodiments, the location of the specified building can be provided by entities using the exemplary system 100 such as, for example, an organization providing constructions services, roofing contractors, or the like. In response, the image source 103 provides the one or more aerial images 105 of the specified building. In a typical embodiment, the received aerial images 105 are stored as image data in at least one of the plurality of databases 106, 108 for further processing by components of the exemplary system 100. Obtaining aerial images 105 of the specified building may include various forms of geo-coding, performed by components of the of the exemplary system 100. In one embodiment, components of the exemplary system 100 geo-codes a provided street address into latitude and longitude coordinates, which are then used to look up (e.g., query at least one of the plurality of databases 106, 108) aerial images of the specified building.

FIG. 2 illustrates an exemplary image 200 and a corresponding mask 202. The mask 202 indicates (in white) which sections of the image are roof areas and indicates (in black) which sections of the image are non-roof areas. The exemplary system 100 utilizes the exemplary image 200 and the corresponding mask 202 of the specified building to determine roof measurement information. In a typical embodiment, the roof measurement information may include measurements such as, for example, lengths of edges of sections of the roof, pitches of sections of the roof, areas of sections of the roof, or the like. The model of the roof and/or the roof measurement information is then used to generate a roof estimate report. The roof estimate report includes one or more-line drawings of the roof of the building, which are annotated with information about the roof, such as lengths of the edges of sections of the roof, pitches of sections of the roof, areas of sections of the roof, of the like.

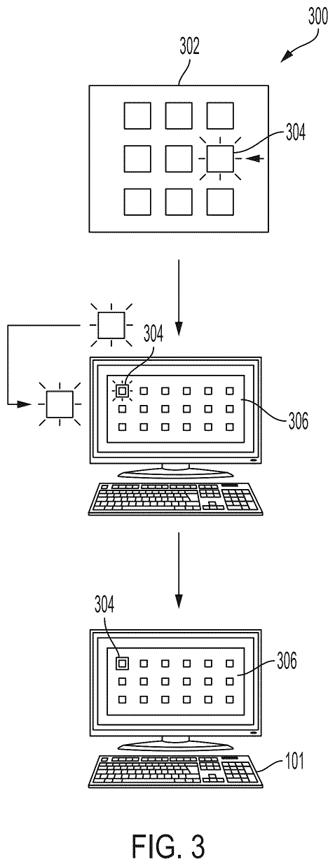

FIG. 3 is a visual representation 300 for installing a custom-coded plugin widget 304 on a website of an entity. For illustrative purposes, FIG. 3 will be described relative to FIGS. 1-2. The exemplary system 100 utilizes the custom-coded plugin widget 304 that is installable on a backend of the website of the entity. In a typical embodiment, the entity may be operated by a roof construction/repair company that generates roof estimate reports that are used internally and/or provided to individuals 101 such as, for example, property owners, or the like.

According to exemplary embodiments, the exemplary system 100 automates the roof replacement or repairs process by providing estimates to repair or replace the roof on the specified building without a need for the contractor to physically visit the house for roof inspection. The exemplary system 100 may be operated in various ways. In one embodiment, the exemplary system 100 executes as, for example, a desktop computer application. In another embodiment, the exemplary system 100 executes as a network-accessible service via, for example, a Web server, which may be operated remotely by the individual 101. In another embodiment, the exemplary system 100 utilizes the custom-coded plugin widget 304 (e.g., software), installable on a backend of the website of the entity, which creates a simple and easy user interface in the form of a series of pop-up windows for individuals 101 visiting the website of the entity.

According to exemplary embodiments, the purpose of the custom-coded plugin widget 304 is, for example, to retrieve, analyze, organize and distribute information necessary for the individual 101 to purchase a new roof for their home. Such a software product is currently not in existence. In a typical embodiment, the custom-coded plugin widget 304 is entirely self-contained and can be dragged and dropped into an existing website infrastructure of the entity to immediately and accurately analyze multiple unrelated data points to generate all facets of an individual's experience. To install the custom-coded plugin widget 304, an employee of the entity can navigate online to a plug-in library 302 (e.g., repository of modular collection of software components), obtain a valid product license key, and download the custom-coded plugin widget 304 onto their website 306 (e.g., website of the entity), allowing instant access to a fully-functioning, licensed instance of software on the entity website to immediately and accurately generate the required information on behalf of individuals 101 such as, for example, customers of the entity requesting roofing estimates.

In a typical embodiment, the custom-coded plugin widget 304 works by aggregating information such as, for example, user data, building address, building coordinates, roof images/dimensions (via external entities or image sources 103), market value of custom range of roofing materials based on, for example, location, availability, quantity, variable labor cost, user credit data (via third-party software data), or the like. In a typical embodiment, the custom-coded plugin widget 304 compiles the data and interprets total cost based on, for example, financing options, materials cost, labor cost, building location, dimensions of the roof, or the like.

In a typical embodiment, the custom-coded plugin widget 304 compiles and stores the data in at least one of the plurality of databases 106, 108. The data is then simultaneously logged into a participating customer relationship management software (CRM), as well as emailed to the individual 101. The custom-coded plugin widget 304 allows individuals 101 to choose from a variety of materials, each with a corresponding price in at least one of the plurality of databases 106, 108. According to exemplary embodiments, the plurality of databases 106, 108 may be updated in real-time to reflect pricing adjustments. In addition, location data provided by the individual 101 pulls directly from the plurality of databases 106, 108 as well, allowing real-time fluctuations in labor costs to reflect in the estimate to the individual 101. Additionally, utilizing the exemplary custom-coded plugin widget 304, the individual 101 can request and receive information such as, for example, accurate pricing and scheduling data through integration with a plurality of third-party application programming interfaces (APIs) aimed at, for example, estimate calculations, scheduling/lead management, or the like. According to exemplary embodiments, the custom-coded plugin widget 304 enables immediate and accurate holistic display of, for example, materials, pricing, scheduling and data to display for the individual 101 from, for example, a pop-up window. In a typical embodiment, every API call is made on the server-side such that the plugin's API credentials, or other sensitive data are not exposed the individual 101 maintaining security and confidentiality. According to exemplary embodiments, application pop-up code, pop-up design, and API call code reside in the exemplary custom-coded plugin widget 304.

The exemplary custom-coded plugin widget 304 has the capability to install on any website and can be integrated in a short period of time. Additionally, the exemplary custom-coded plugin widget 304 provides a short code to render a pop-up screen, which can be strategically included anywhere on the website. The purpose of the custom-coded plugin widget 304 is to create a seamless series of actions to enable immediate and accurate pricing data to display for the individual 101 from within the custom-coded plugin widget 304.

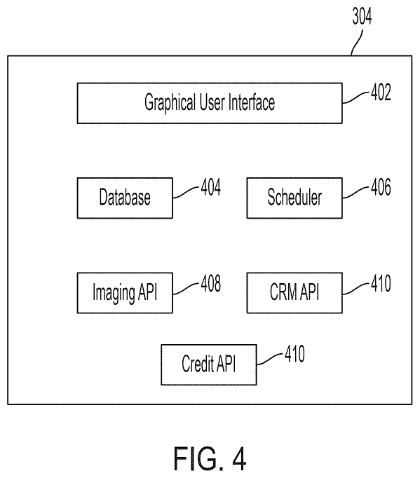

FIG. 4 illustrates the custom-coded plugin widget 304. For illustrative purposes, FIG. 4 will be described relative to FIGS. 1-3. The custom-coded plugin widget 304 includes a plurality of components. For example, the custom-coded plugin widget 304 includes a user-facing component 402 in the form of a plurality of pop-up windows that incorporate, for example, video, images and calendars to navigate individuals 101 through a series of questions. In a typical embodiment, the series of questions may include, for example, name, address, E-mail address, phone number, or the like. After responding to the series of questions, the individual 101 is presented with estimates, consultation appointment details, financing options, or the like via a plurality of pop-up windows. The custom-coded plugin widget 304 further includes a custom database 404 that is configured to store information corresponding to pricing of material and/or labor and a scheduler 406 that is configured to generate consultation appointment E-mail to the entity. The custom-coded plugin widget 304 further includes an imaging API 408 that is configured to retrieve specified building details, a CRM API 410 that is configured to generate consultation appointment E-mail's to the individual 101, and a credit API that is configured to determine financing options for the individual 101. For illustrative purposes, the custom-coded plugin widget 304 is illustrated as having six components; however, in other embodiments, the custom-coded plugin widget 304 can have additional components as dictated by design requirements.

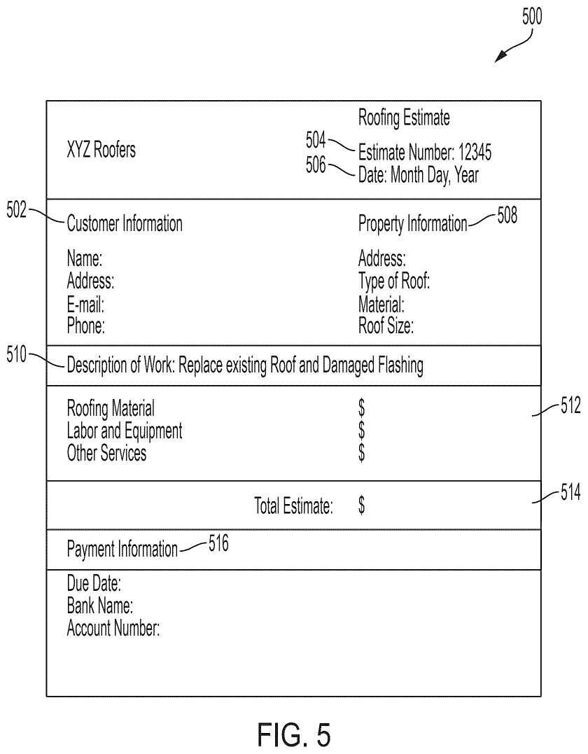

FIG. 5 illustrates a visual representation of an exemplary roofing estimate 500. For illustrative purposes, FIG. 5 will be described relative to FIGS. 1-4. In a typical embodiment, the roofing estimate 500 may be presented to the individual 101 via, for example, a pop-up window of the custom-coded plugin widget 304. The roofing estimate 500 is a comprehensive document that provides a blueprint of a project outlining what the individual 101 (e.g., customer) pays, and the services performed by the entity (e.g., contractor). For example, the exemplary roofing estimate 500 includes customer information 502 such as, for example, name, address, E-mail address, phone number and the like. The exemplary roofing estimate 500 further includes an estimate number 504, date of estimate 506, and property information requiring repairs 508. The exemplary roofing estimate 500 further includes a description of work 510, itemized cost of the project 512, a total cost of the project 514, and payment information 516. For illustrative purposes, the roofing estimate 500 is illustrated with the information listed above; however, in other embodiments, the roofing estimate can have additional details related to the roofing project as dictated by customer requirements.

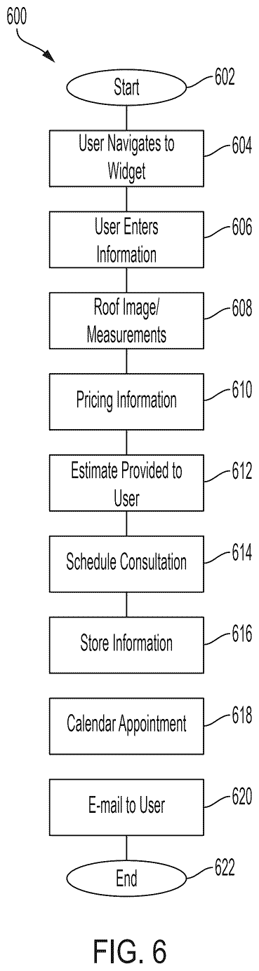

FIG. 6 is a flow diagram 600 of an illustrative process for providing estimates for projects in an automated manner using the exemplary system 100. For illustrative purposes, FIG. 6 will be described herein relative to 1-5. The process 600 begins at step 602. At step 604, the individual 101 visits a website of the entity and navigates to the custom-coded plugin widget 304 (e.g., software) that is installable on a backend of the website of the entity. The custom-coded plugin widget 304 creates a simple and easy user interface for the individual 101 in the form of a series of pop-up windows. In a typical embodiment, the individual 101 may be, for example, a user or a customer requesting estimates for a construction project. According to exemplary embodiments, the custom-coded plugin widget 304 retrieves, analyzes, organizes and distributes information necessary for the individual 101 to purchase a new roof for their home. In a typical embodiment, the custom-coded plugin widget 304 is entirely self-contained and can be drag-and-dropped into an existing website infrastructure of the entity to immediately and accurately analyze multiple unrelated data points to generate all facets of an individual's experience. At step 606, the individual 101, via a series of pop-up windows, enters relevant information such as, for example, name, E-mail, phone number, location information, desired roof material, or the like.

At step 608, using the information entered in step 606, at least one server or cloud-computing system 102, 104 of the exemplary system 100 communicates with other entities or image sources 103 such as, for example, Google™, Eagleview, or the like to obtain aerial images of the specified building. In a typical embodiment, the image source 103 may be any provider of aerial images 105 of the building for which a roof estimate is being generated. In one embodiment, the image source 103 includes a computing system that provides access to a repository of aerial images 105 of one or more buildings. The exemplary system 100 utilizes the aerial images 105 to generate the exemplary image 200 and the corresponding mask 202 for the specified building to determine roof measurement information. In a typical embodiment, the roof measurement information may include measurements such as, for example, lengths of edges of sections of the roof, pitches of sections of the roof, areas of sections of the roof, or the like.

At step 610, the custom-coded plugin widget 304 sends the user's roofing material information as well as the roof dimensions to a custom database 404 containing material pricing information. At step 612, an estimate 500 along with an image 200 for the specified building are displayed in, for example, a pop-up window to the individual 101 for review and approval. At step 614, upon approval by the individual 101, the individual 101 is invited to book a consultation using a calendar interface connected to the CRM. At step 616, the information corresponding to the estimate and roof measurements are stored in the at least one of the plurality of databases 106, 108, 404. Once the consultation (e.g., date and time) is booked by the individual 101, the exemplary system 100 uses built-in automation to populate the individual's calendar and generates an E-mail to a contractor of the entity with the consultation details. At step 620, the exemplary system 100 uses built-in automation to generates an E-mail to the individual 101 to confirm the estimate 500 and consultation details. At step 622, the process 600 ends.

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A method for providing an estimate for a roof replacement project, the method utilizing a system comprising at least one server, at least one database and at least one communication device that are configured for wireless data communication over a network, the method comprising:
installing, on a website of an entity, a custom-coded plugin widget comprising at least one pop-up interface;
accessing, by an individual, the website;
navigating, by the individual, the website to a first pop-up interface;
inputting by the individual, via the first pop-up interface, information corresponding to the individual and the roof replacement project; and
wherein the custom-coded plugin widget is configured to communicate with the system to generate, based on the information, an estimate for the roof replacement project and display, via a second pop-up interface, the estimate to the individual for approval.

2. The method of claim 1, wherein the custom-coded plugin widget is self-contained.

3. The method of claim 2, wherein the custom-coded plugin widget is configured to be dragged and dropped into the website.

4. The method of claim 1, wherein the entity comprises an organization providing services for the roof replacement project.

5. The method of claim 1, wherein the individual comprises a customer requesting the estimate for the roof replacement project.

6. The method of claim 1, wherein the information comprises at least one of a name of the individual, a phone number of the individual, an E-mail address of the individual, a location of a building requiring the roof replacement project, and desired materials for the roof replacement project.

7. The method of claim 6, wherein utilizing the information, the system communicates with at least one image source to obtain aerial images of the location.

8. The method of claim 7, further comprising:
determining, utilizing the aerial images, roof measurement information; and
wherein the roof measurement information comprises at least one of lengths of edges of sections of the roof, pitches of sections of the roof, and areas of sections of the roof.

9. The method of claim 1, further comprising:
upon accepting the estimate, forwarding, to the individual, an invitation to schedule a consultation using a calendar interface;
accepting, by the individual, the invitation; and
generating, by the system, an E-mail to the entity and the individual with consultation details.

10. The method of claim 1, wherein the installing comprises:
navigating to a repository containing the custom-coded plugin widget; and
downloading onto the website of the entity, the custom-coded plugin widget.

11. The method of claim 1, further comprising:
requesting by the individual, utilizing the custom-coded plugin widget, data corresponding to at least one of pricing and scheduling through a plurality of third-party application programming interfaces (APIs).

12. The method of claim 11, wherein the request is initiated on a server-side to maintain security and confidentiality.

13. The method of claim 1, wherein the custom-coded plugin widget comprises a plurality of components.

14. The method of claim 13, wherein the plurality of components comprise:
a user-facing component;
a custom database;
a scheduler;
an imaging application programming interface (API);
a customer relationship management software (CRM) (API); and
a credit API.

15. A system comprising:
at least one server;
at least one database;
at least one communication device;
wherein the least one server, the at least one database, and the at least one communication device are each communicably coupled to a network for data communication;
wherein at least one of the at least one server, the at least one database and the at least one communication device are configured to:
install, on a website of an entity, a custom-coded plugin widget comprising at least one pop-up interface;
wherein an individual accesses the website, navigates the website to a first pop-up interface and inputs, via the first pop-up interface, information corresponding to the individual and the roof replacement project; and
wherein the custom-coded plugin widget is configured to generate, based on the information, an estimate for the roof replacement project and display, via a second pop-up interface, the estimate to the individual for approval.

16. The system of claim 15, wherein the custom-coded plugin widget is configured to be dragged and dropped into the website.

17. The system of claim 15, wherein the entity comprises an organization providing services for the roof replacement project.

18. The system of claim 15, wherein the individual comprises a customer requesting the estimate for the roof replacement project.

19. The system of claim 15, wherein the information comprises at least one of a name of the individual, a phone number of the individual, an E-mail address of the individual, a location of a building requiring the roof replacement project, and desired materials for the roof replacement project.

20. The system of claim 15, wherein the custom-coded plugin widget comprises:
a user-facing component;
a custom database;
a scheduler;
an imaging application programming interface (API);
a customer relationship management software (CRM) (API); and
a credit API.
